(19) United States
(12) Patent Application Publication
(10) Pub. No.: US 2025/0141615 A1
(43) Pub. Date: May 1, 2025

(54) COMMON TIMING ADVANCE GROUP FOR MULTIPLE TRANSMIT RECEIVE POINT OPERATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/833,656

(22) PCT Filed: Mar. 31, 2022
(86) PCT No.: PCT/CN2022/084481

§ 371 Date: Jul. 26, 2024

(51) Int. Cl. H04L 5/00

(52) U.S. Cl. CPC H04L 5/0048

(57) ABSTRACT

Various aspects of the present disclosure generally relate to wireless communication. In some aspects, a user equipment (UE) may receive an indication of at least two timing advance groups (TAGs) per serving cell for multiple transmit receive point operation, wherein each TAG is associated with an uplink or joint transmission configuration indicator (TCI) state. The UE may receive an activation message that activates one or more TCI states for one or more uplink channels or reference signals. The UE may select a common TAG for the one or more uplink channels or reference signals based at least in part on a common TAG rule. The UE may transmit a reference signal or a communication on an uplink channel using the common TAG. Numerous other aspects are described.

### FIELD OF THE DISCLOSURE

Aspects of the present disclosure generally relate to wireless communication and to techniques and apparatuses for selecting a common timing advance group for multiple transmit receive point operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 illustrates an example logical architecture of a distributed radio access network, in accordance with the present disclosure.

FIG. 5 is a diagram illustrating an example of multiple transmit receive point communication, in accordance with the present disclosure.

FIG. 6 is a diagram illustrating an example of a timing advance (TA) configuration, in accordance with the present disclosure.

FIG. 7 is a diagram illustrating an example of using a common TA group (TAG), in accordance with the present disclosure.

FIG. 8 is a diagram illustrating an example of using a common TAG, in accordance with the present disclosure.

FIG. 9 is a diagram illustrating an example of using a common TAG, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIGS. 12-13 are diagrams of example apparatuses for wireless communication, in accordance with the present disclosure.

### SUMMARY

Some aspects described herein relate to a method of wireless communication performed by a user equipment (UE). The method may include receiving an indication of at least two timing advance groups (TAGs) per serving cell for multiple transmit receive point (TRP) operation, where each TAG is associated with or included in an uplink or joint transmission configuration indicator (TCI) state. The method may include receiving an activation message that activates one or more TCI states for one or more uplink channels or reference signals. The method may include selecting a common TAG for the one or more uplink channels or reference signals based at least in part on a common TAG rule. The method may include transmitting a reference signal or a communication on an uplink channel using the common TAG.

Some aspects described herein relate to a method of wireless communication performed by a network entity. The method may include transmitting an indication of at least two TAGs per serving cell for multiple TRP operation, where each TAG is associated with or included in an uplink or joint TCI state. The method may include transmitting an activation message that activates one or more TCI states for one or more uplink channels or reference signals. The method may include selecting a common TAG for the one or more uplink channels or reference signals based at least in part on a common TAG rule. The method may include receiving a reference signal or a communication on an uplink channel using the common TAG.

Some aspects described herein relate to a UE for wireless communication. The UE may include a memory and one or more processors coupled to the memory. The one or more processors may be configured to receive an indication of at least two TAGs per serving cell for multiple TRP operation, where each TAG is associated with or included in an uplink or joint TCI state. The one or more processors may be configured to receive an activation message that activates one or more TCI states for one or more uplink channels or reference signals. The one or more processors may be configured to select a common TAG for the one or more uplink channels or reference signals based at least in part on a common TAG rule. The one or more processors may be configured to transmit a reference signal or a communication on an uplink channel using the common TAG.

Some aspects described herein relate to a network entity for wireless communication. The network entity may include a memory and one or more processors coupled to the memory. The one or more processors may be configured to transmit an indication of at least two TAGs per serving cell for multiple TRP operation, where each TAG is associated with or included in an uplink or joint TCI state. The one or more processors may be configured to transmit an activation message that activates one or more TCI states for one or more uplink channels or reference signals. The one or more processors may be configured to select a common TAG for the one or more uplink channels or reference signals based at least in part on a common TAG rule. The one or more processors may be configured to receive a reference signal or a communication on an uplink channel using the common TAG.

Some aspects described herein relate to a non-transitory computer-readable medium that stores a set of instructions for wireless communication by a UE. The set of instructions, when executed by one or more processors of the UE, may cause the UE to receive an indication of at least two TAGs per serving cell for multiple TRP operation, where each TAG is associated with an uplink or joint TCI state. The set of instructions, when executed by one or more processors of the UE, may cause the UE to receive an activation message that activates one or more TCI states for one or more uplink channels or reference signals. The set of instructions, when executed by one or more processors of the UE, may cause the UE to select a common TAG for the one or more uplink channels or reference signals based at least in part on a common TAG rule. The set of instructions, when executed by one or more processors of the UE, may cause the UE to transmit a reference signal or a communication on an uplink channel using the common TAG.

Some aspects described herein relate to a non-transitory computer-readable medium that stores a set of instructions for wireless communication by a network entity. The set of instructions, when executed by one or more processors of the network entity, may cause the network entity to transmit an indication of at least two TAGs per serving cell for multiple TRP operation, where each TAG is associated with an uplink or joint TCI state. The set of instructions, when executed by one or more processors of the network entity, may cause the network entity to transmit an activation message that activates one or more TCI states for one or more uplink channels or reference signals. The set of instructions, when executed by one or more processors of the network entity, may cause the network entity to select a common TAG for the one or more uplink channels or reference signals based at least in part on a common TAG rule. The set of instructions, when executed by one or more processors of the network entity, may cause the network entity to receive a reference signal or a communication on an uplink channel using the common TAG.

Some aspects described herein relate to an apparatus for wireless communication. The apparatus may include means for receiving an indication of at least two TAGs per serving cell for multiple TRP operation, where each TAG is associated with an uplink or joint TCI state. The apparatus may include means for receiving an activation message that activates one or more TCI states for one or more uplink channels or reference signals. The apparatus may include means for selecting a common TAG for the one or more uplink channels or reference signals based at least in part on a common TAG rule. The apparatus may include means for transmitting a reference signal or a communication on an uplink channel using the common TAG.

Some aspects described herein relate to an apparatus for wireless communication. The apparatus may include means for transmitting an indication of at least two TAGs per serving cell for multiple TRP operation, where each TAG is associated with an uplink or joint TCI state. The apparatus may include means for transmitting an activation message that activates one or more TCI states for one or more uplink channels or reference signals. The apparatus may include means for selecting a common TAG for the one or more uplink channels or reference signals based at least in part on a common TAG rule. The apparatus may include means for receiving a reference signal or a communication on an uplink channel using the common TAG.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

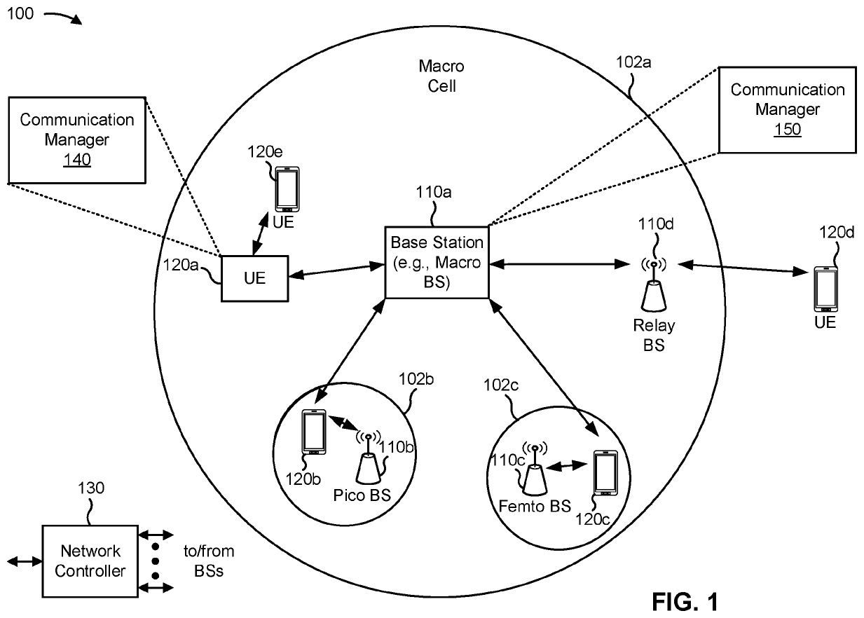

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of at least two timing advance groups (TAGs) per serving cell for multiple TRP operation, where each TAG is associated with an uplink or joint transmission configuration indicator (TCI) state. The communication manager 140 may receive an activation message that activates one or more TCI states for one or more uplink channels or reference signals and select a common TAG for the one or more uplink channels or reference signals based at least in part on a common TAG rule. The communication manager 140 may transmit a reference signal or a communication on an uplink channel using the common TAG. Additionally, or alternatively, the communication manager 140 may perform one or more other operations described herein.

In some aspects, a network entity (e.g., a base station 110) may include a communication manager 150. As described in more detail elsewhere herein, the communication manager 150 may transmit an indication of at least two TAGs per serving cell for multiple TRP operation, where each TAG is associated with an uplink or joint TCI state. The communication manager 150 may transmit an activation message that activates one or more TCI states for one or more uplink channels or reference signals. The communication manager 150 may select a common TAG for the one or more uplink channels or reference signals based at least in part on a common TAG rule and receive a reference signal or a communication on an uplink channel using the common TAG. Additionally, or alternatively, the communication manager 150 may perform one or more other operations described herein.

As indicated above, FIG. 1 is provided as an example. Other examples may differ from what is described with regard to FIG. 1.

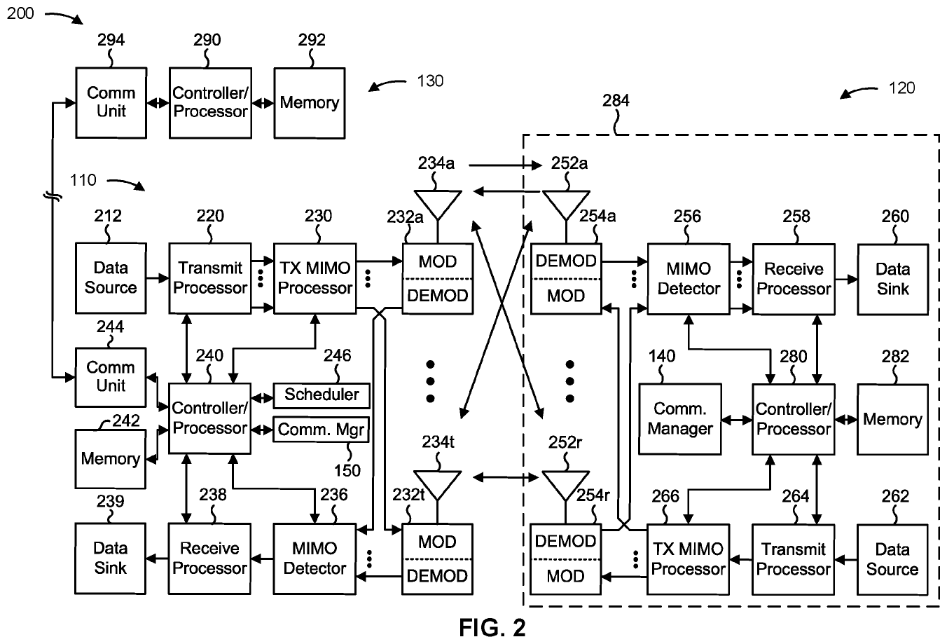

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

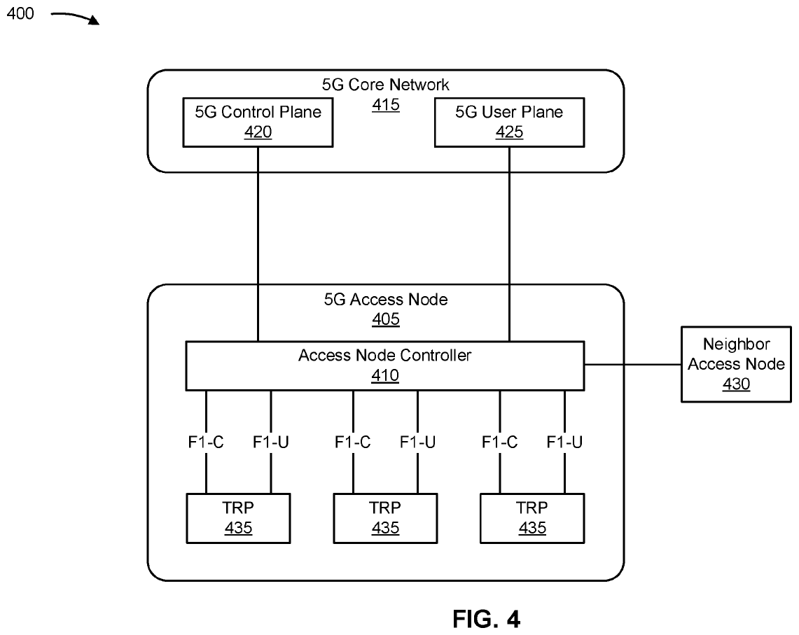

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

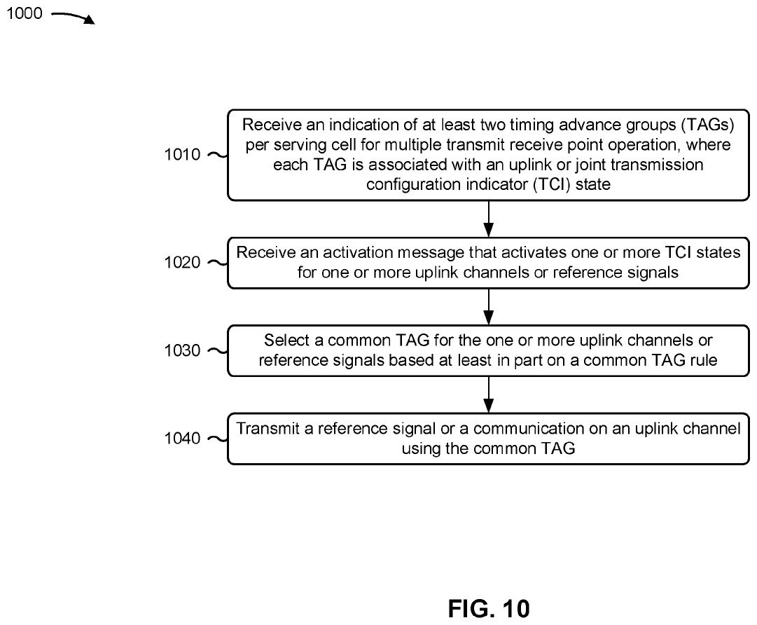

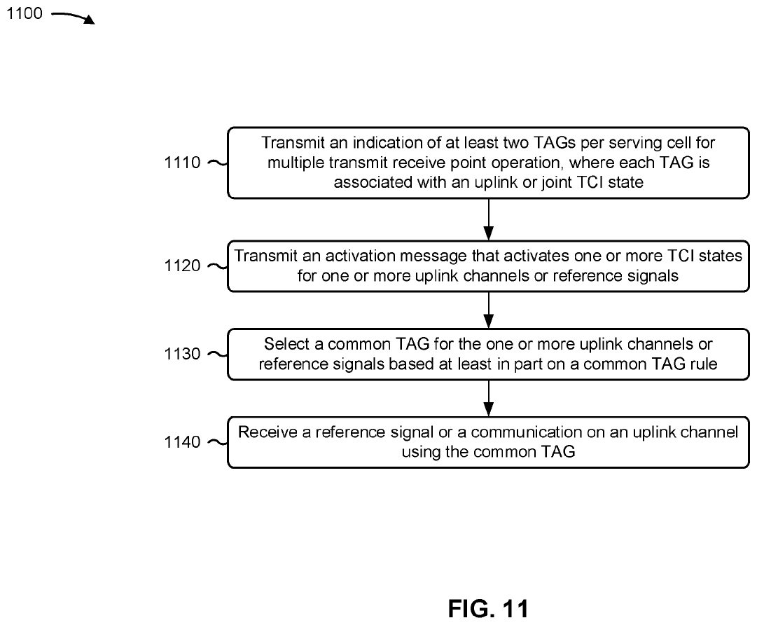

A controller/processor of a network entity (e.g., the controller/processor 240 of the base station 110), the controller/processor 280 of the UE 120 (mobile station), and/or any other component(s) of FIG. 2) may perform one or more techniques associated with using a common TAG for multiple TRP operation, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving an indication of at least two TAGs per serving cell for multiple TRP operation, where each TAG is associated with or included in an uplink or joint TCI state; means for receiving an activation message that activates one or more TCI states for one or more uplink channels or reference signals; means for selecting a common TAG for the one or more uplink channels or reference signals based at least in part on a common TAG rule; and/or means for transmitting a reference signal or a communication on an uplink channel using the common TAG. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a base station 110) includes means for transmitting an indication of at least two TAGs per serving cell for multiple TRP operation, where each TAG is associated with an uplink or joint TCI state; means for transmitting an activation message that activates one or more TCI states for one or more uplink channels or reference signals; means for selecting a common TAG for the one or more uplink channels or reference signals based at least in part on a common TAG rule; and/or means for receiving a reference signal or a communication on an uplink channel using the common TAG. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

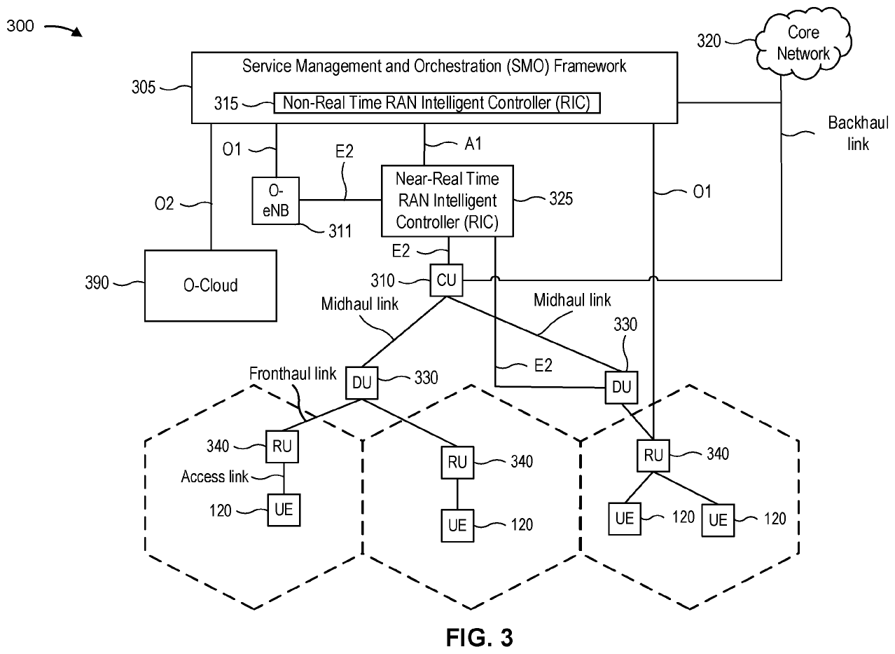

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity at the RAN may include a CU, a DU, an RU, or any combination of CUs, DUs, and RUs. A network entity at the RAN may include a disaggregated base station or one or more components of the disaggregated base station, such as a CU, a DU, an RU, or any combination of CUs, DUs, and RUs. A network entity at the RAN may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400 (e.g., disaggregated base station). In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, a RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

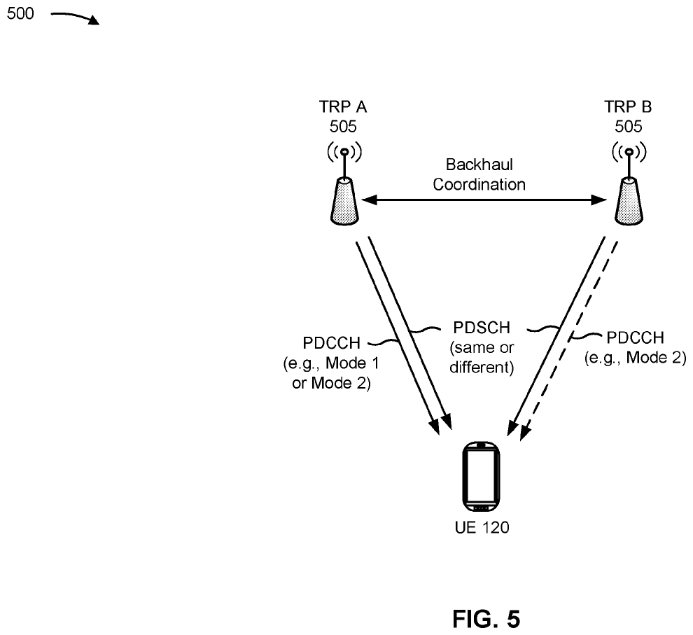

FIG. 5 is a diagram illustrating an example 500 of multi-TRP communication (sometimes referred to as multi-panel communication), in accordance with the present disclosure. As shown in FIG. 5, multiple TRPs 505 may communicate with the same mobile station (e.g., same UE 120). A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110) and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1). A UE may receive multiple DCI (mDCI) from the multiple TRPs or a single DCI (sDCI) for the multiple TRPs.

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

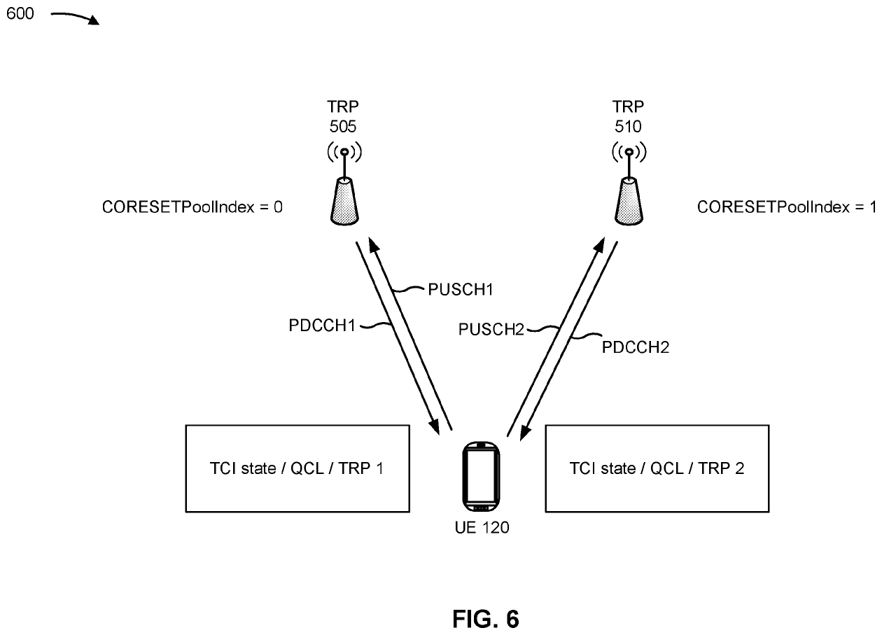

FIG. 6 is a diagram illustrating an example 600 of a TA configuration, in accordance with the present disclosure.

A UE (e.g., a UE 120) may use a TA to adjust when the UE 120 transmits a communication, in order to align an arrival time for the communication with a subframe timing at a TRP (e.g., TRP 505, TRP 510) or another network entity. The network entity may transmit a TA command (e.g., in a MAC CE via the TRP) that includes a TA value (e.g., time duration) that indicates how early the UE 120 is to transmit a communication to account for the propagation delay. For example, a single downlink timing may be used, where the same TA is used for multiple communications from the first TRP 505 and the second TRP 505. There may be two TAs because the two TRPs may be at different distances. Accordingly, a separate downlink timing may be used, where different TAs are used for different communications.

If there are multiple serving cells, TAGs may be used. A TAG may include one or more serving cells with the same TA for an uplink carrier. One of the serving cells may be a timing reference cell for the entire TAG. RRC signaling may map each serving cell to a TAG, which may be identified with a TAG identifier (ID) in a TA command MAC control element (CE).

TAs may be configured for multiple TRP (mTRP) operations, which may include single downlink control information (sDCI) or multiple DCI (mDCI) mTRP operations. In mDCI mTRP operation, each TRP may be associated with a control resource set (CORESET) pool index. Example 600 shows that TRP 505 may be associated with CORESETs of CORESET pool index 0 (zero) or of no CORESET pool index and TRP 510 may be associated with CORESETs of CORESET pool index 1.

A network entity (e.g., a base station 110) may configure the UE 120 with TCI states for uplink channels or reference signals and then activate the TCI states. Different TCI states may be activated or indicated for different channels and reference signals for different TRPs. Example 600 shows a first TCI state for an uplink channel (PUCCH1) to TRP 505. The first TCI state for the uplink channel may be QCLed with a TCI state for PDCCH1, which is associated with TRP 505, and represented as TCI state/QCL/TRP 1. Example 600 also shows a second TCI state for an uplink channel (PUCCH2) to TRP 510. The second TCI state for the uplink channel may be QCLed with a TCI state for PDCCH2, which is associated with TRP 510, and represented as TCI state/QCL/TRP 2.

TAGs may be used for mTRP operations. For example, for TRP 505 and TRP 510, the UE 120 may be enabled with two TAs for mTRP operation, where different TAs may be applied to different TRPs. The UE 120 may be configured with two TAGs per serving cell, and each TAG (or corresponding indicator or TAG identifier (ID)) may be configured within or associated with each uplink or joint (uplink/downlink) TCI state. However, if different TAGs are associated with different TCI states for a serving cell, it has not been specified which TAG is to be used for uplink channels or reference signals scheduled for the same CORESET pool index (same TRP). Without specifying which TAG of multiple TAGs to use for uplink channels or reference signals for the same CORESET pool index, some TAs may be mismatched. As a result, communications may degrade, and processing resources and signaling resources may be wasted.

As indicated above, FIG. 6 is provided as an example. Other examples may differ from what is described with regard to FIG. 6.

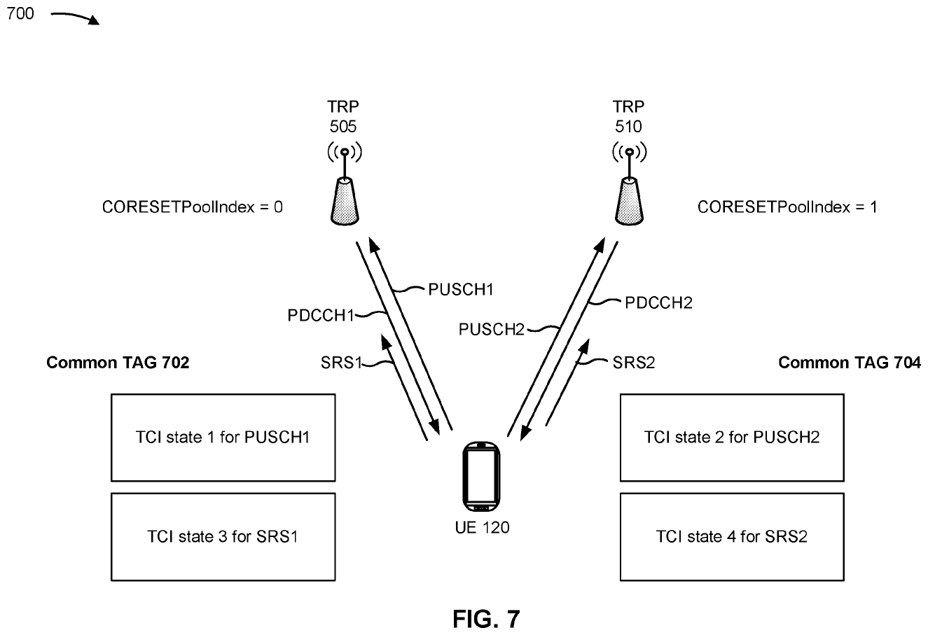

FIG. 7 is a diagram illustrating an example 700 of using a common TAG, in accordance with the present disclosure.

According to various aspects described herein, if the network entity configures different TCIs for uplink channels or reference signals associated with the same CORESET pool index (i.e., same TRP), the UE 120 may select a common TAG for the uplink channels or reference signals associated with the CORESET pool index. In some aspects, the UE 120 may select the common TAG according to a common TAG rule when two TAGs are configured per serving cell and each TAG is associated with or included in an uplink or joint TCI state. For example, the common TAG rule may specify that if uplink channels or reference signals are scheduled by DCIs in CORESETs of the same CORESET pool index, the uplink channels or reference signals scheduled by the DCIs are to use the common TAG. Accordingly, the uplink channels or reference signals applying the uplink or joint TCI states may use the TA value based on the common TAG. In some aspects, a TCI activation MAC CE may activate one or more TCI states associated with a CORESET pool index, and the common TAG rule may specify that TCI states activated by the same MAC CE of the same CORESET pool index are to use the common TAG. In some aspects, the common TAG rule may specify that if a TAG is indicated for uplink or joint TCI states, the TAG that is indicated is to be the common TAG and other TAGs for other uplink or joint TCI states are to be ignored. In some aspects, the TAG that is indicated or the common TAG that is selected for multiple TCIs may have a lowest ID among activated TCI states or a highest ID among activated TCI states.

Example 700 shows a TCI state 1 for PUSCH1 and a TCI state 3 for SRS1. In some aspects, both TCI state 1 and TCI state 3 may be activated, by a TCI activation MAC CE, to be associated with CORESET pool index 0. Each of these TCI states may be configured with a different TAG. The UE 120 may, according to the common TAG rule, select a TAG to be a common TAG 702 for both TCI state 1 and TCI state 3 for CORESET pool index 0. For example, the common TAG 702 may be the TAG associated with the uplink TCI state or joint TCI state of the lowest TCI codepoint ID in the TCI activation MAC CE. In another example, the common TAG 702 may be the TAG associated with the uplink TCI state or joint TCI state of the lowest TCI ID in the TCI activation MAC CE. The UE 120 may likewise select another common TAG 704 for both TCI state 2 (for PUSCH2) and TCI state 4 (for SRS2) for CORESET pool index 1.

In some aspects, both PUSCH1 and SRS1 may be scheduled by the DCIs in CORESETs of the same CORESET pool index. For example, PUSCH1 and SRS1 may be scheduled by the DCIs in CORESETs of CORESET pool index 0. The UE 120 may be indicated with two TCI states (TCI state 1 and TCI state 3), and the same TAG may be associated with or included in the two TCI states. The UE 120 may likewise select another common TAG 704 for both PUSCH2 and SRS2 scheduled by the DCIs in CORESETs of the same CORESET pool index 1.

In some aspects, if no TAG is configured or associated with an uplink or joint TCI state for uplink channels or reference signals (to conserve signaling resources), the UE 120 may select a default TAG to be the common TAG for the uplink channels or reference signals. For example, the default TAG may be the TAG applied for a default CORESET pool index, such as CORESET pool index 0. For another example, the default TAG may be configured by RRC signaling or determined by another rule.

By specifying use of a common TAG for uplink channels or reference signals of the same CORESET pool index (same TRP), the UE 120 may have more certainty as to the TA that is to be used for the uplink channels or reference signals for multiple CORESET pool indices in mTRP operation. As a result, the UE 120 and the network entity may experience less degradation of the communications and may conserve processing resources.

As indicated above, FIG. 7 is provided as an example. Other examples may differ from what is described with regard to FIG. 7.

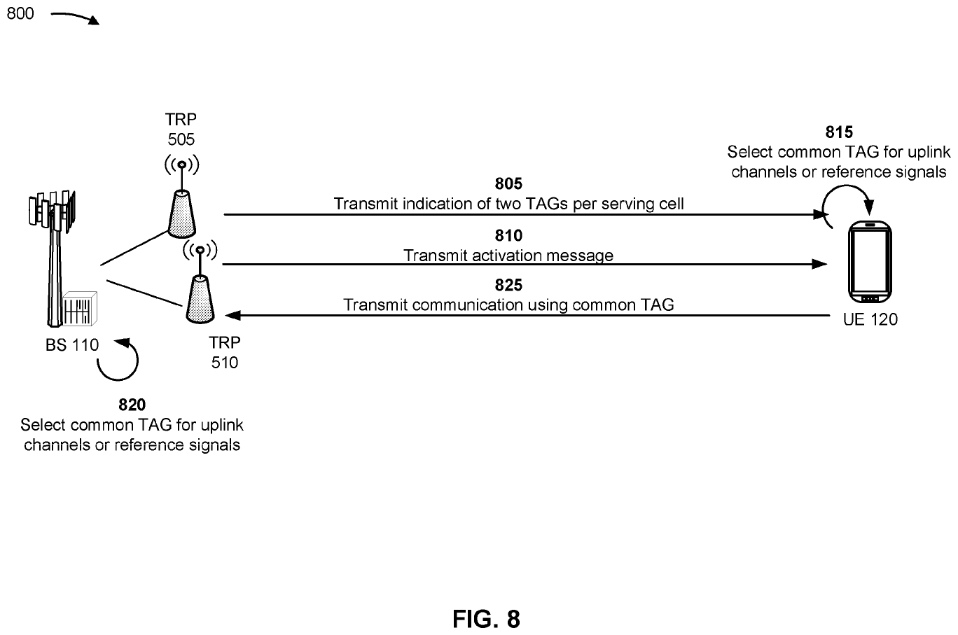

FIG. 8 is a diagram illustrating an example 800 of using a common TAG, in accordance with the present disclosure. As shown in FIG. 7, a network entity (e.g., base station 110) and the UE 120 may communicate with one another. The base station 110 may control at least two TRPs, such as TRP 505 and TRP 510. Each TRP may be associated with a CORESET pool index and one or more serving cells.

As shown by reference number 805, the base station 110 may transmit an indication of two (or more) TAGs per serving cell. The two TAGs may be different. Alternatively, in some aspects, the base station 110 may control use of a common TAG by transmitting two TAGs that are the same (common TAG) for different TCI states.

Multiple TCI states may be configured for a set of uplink channels or reference signals, and each TAG (or corresponding indicator or TAG ID) may be configured within or associated with each uplink or joint TCI state. As shown by reference number 810, the base station 110 may transmit an activation message to activate the TCI states configured for the uplink channels or reference signals.

As shown by reference number 815, the UE 120 may select the common TAG 702 for the uplink channels or reference signals based at least in part on a common TAG rule. Multiple TCI states may be associated with the common TAG 702. The UE 120 may select the common TAG 702 for a CORESET pool index from among different TAGs configured by the base station 110 for the CORESET pool index. In some aspects, the UE 120 may select, as the common TAG 702, a TAG that is indicated by the base station 110 to be the common TAG 702. In some aspects, the UE 120 may select the TAG that is associated with an activated TCI state or other activation indication in a MAC CE. As shown by reference number 820, the base station 110 may also select the common TAG 702 according to the same common TAG rule used by the UE 120.

As shown by reference number 825, the UE 120 may transmit a communication using the common TAG 702. The base station 110 may expect the UE 120 to use the common TAG 702 and may receive and decode the communication using the common TAG 702.

As indicated above, FIG. 8 is provided as an example. Other examples may differ from what is described with respect to FIG. 8.

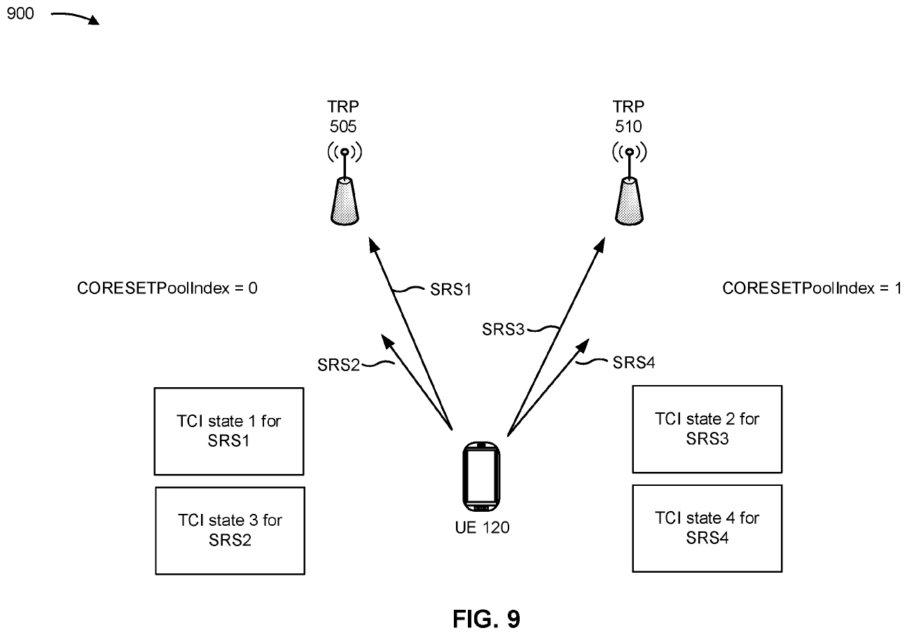

FIG. 9 is a diagram illustrating an example 900 of using a common TAG, in accordance with the present disclosure.

In some aspects, the uplink channels or reference signals may include one or more SRSs in an SRS resource set. Example 900 shows that the TCI state 1 may be configured for SRS1, TCI state 3 may be configured for SRS2, TCI state 2 may be configured for SRS3, and TCI state 4 may be configured for SRS4. SRS1 and SRS2 may be in an SRS resource set, and SRS3 and SRS4 may be in another SRS resource set.

The UE 120 may select a common TAG for SRSs in the same SRS resource set. For example, the UE 120 may select a common TAG for SRS1 and SRS2 if SRS1 and SRS2 are in the same SRS resource set. The common TAG or different TAGs may be selected if SRS1 and SRS2 are from different SRS resource sets.

In some aspects, the common TAG rule may specify that if a TAG is indicated for an uplink or joint TCI state of an SRS resource, the TAG that is indicated is to be the common TAG and other TAGs for other uplink or joint TCI states are to be ignored. The TAG that is indicated or the common TAG that is selected for multiple SRSs in an SRS resource set may be the TAG that is associated with a lowest ID among SRSs in an SRS resource set or a highest ID among SRSs in an SRS resource set. For example, the lowest or highest ID may be the SRS resource ID, or the TCI state ID of the SRS resource.

In some aspects, if no TAG is configured or associated with an uplink or joint TCI state for SRSs, the UE 120 may select a default TAG to be the common TAG for the SRSs in an SRS resource set. The default TAG may be configured by RRC signaling or determined by another rule. For example, a TAG to be applied for an SRS resource set may be the TAG applied to a default TCI state, or a default TRP applicable to the SRS resource set.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with or included in using a common TAG for multiple TRP operation.

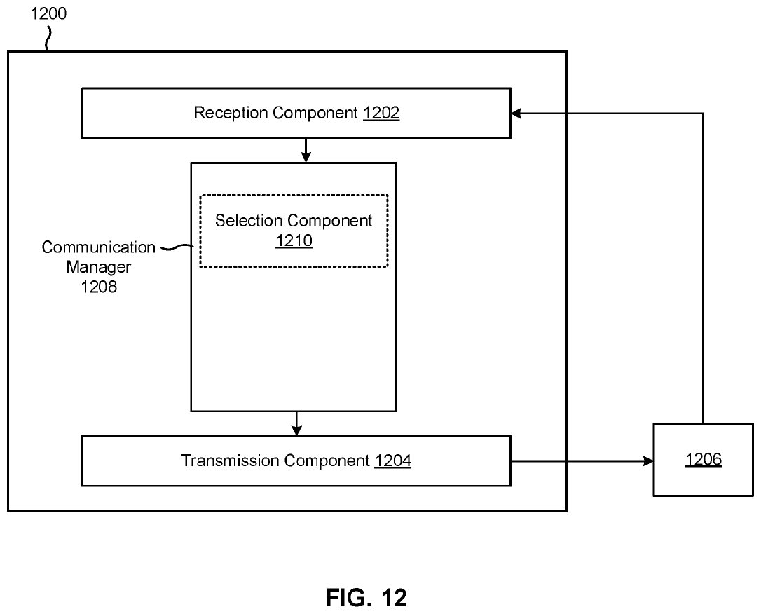

As shown in FIG. 10, in some aspects, process 1000 may include receiving an indication of at least two TAGs per serving cell for multiple TRP operation, where each TAG is associated with or included in an uplink or joint TCI state (block 1010). For example, the UE (e.g., using communication manager 1208 and/or reception component 1202 depicted in FIG. 12) may receive an indication of at least two TAGs per serving cell for multiple TRP operation, where each TAG is associated with or included in an uplink or joint TCI state, as described above in connection with FIGS. 5-9.

As further shown in FIG. 10, in some aspects, process 1000 may include receiving an activation message that activates one or more TCI states for one or more uplink channels or reference signals (block 1020). For example, the UE (e.g., using communication manager 1208 and/or reception component 1202 depicted in FIG. 12) may receive an activation message that activates one or more TCI states for one or more uplink channels or reference signals, as described above in connection with FIGS. 5-9.

As further shown in FIG. 10, in some aspects, process 1000 may include selecting a common TAG for the one or more uplink channels or reference signals based at least in part on a common TAG rule (block 1030). For example, the UE (e.g., using communication manager 1208 and/or selection component 1210 depicted in FIG. 12) may select a common TAG for the one or more uplink channels or reference signals based at least in part on a common TAG rule, as described above in connection with FIGS. 5-9. In some aspects, the common TAG may be selected per CORESET pool index or per TRP.

As further shown in FIG. 10, in some aspects, process 1000 may include transmitting a reference signal or a communication on an uplink channel using the common TAG (block 1040). For example, the UE (e.g., using communication manager 140 and/or transmission component 1204 depicted in FIG. 12) may transmit a reference signal or a communication on an uplink channel using the common TAG, as described above in connection with FIGS. 5-9.

Process 1000 may include additional aspects, such as any single aspect or any combination of aspects described below and/or in connection with one or more other processes described elsewhere herein.

In a first aspect, the common TAG rule specifies that if the one or more uplink channels or reference signals are scheduled by DCI of a same CORESET pool index, the one or more uplink channels or reference signals are to use the common TAG.

In a second aspect, alone or in combination with the first aspect, the common TAG rule specifies that TCI states activated by a same MAC CE of a same CORESET pool index are to use the common TAG.

In a third aspect, alone or in combination with one or more of the first and second aspects, the common TAG rule specifies that uplink or joint TCI states of the one or more uplink channels or reference signals are to use the common TAG.

In a fourth aspect, alone or in combination with one or more of the first through third aspects, the common TAG rule specifies that if a TAG is indicated for uplink or joint TCI states, the TAG that is indicated is to be the common TAG and other TAGs for other uplink or joint TCI states are to be ignored.

In a fifth aspect, alone or in combination with one or more of the first through fourth aspects, the TAG that is indicated has a lowest ID among activated TCI states.

In a sixth aspect, alone or in combination with one or more of the first through fifth aspects, the TAG that is indicated has a highest ID among activated TCI states.

In a seventh aspect, alone or in combination with one or more of the first through sixth aspects, selecting the common TAG includes selecting a TAG that has a lowest ID among the at least two TAGs.

In an eighth aspect, alone or in combination with one or more of the first through seventh aspects, selecting the common TAG includes selecting a TAG that has a highest ID among the at least two TAGs.

In a ninth aspect, alone or in combination with one or more of the first through eighth aspects, the common TAG rule specifies that if no TAG is associated with the one or more uplink channels or reference signals, a default TAG is to be the common TAG.

In a tenth aspect, alone or in combination with one or more of the first through ninth aspects, process 1000 includes receiving the default TAG in an RRC message.

In an eleventh aspect, alone or in combination with one or more of the first through tenth aspects, multiple TCI states are configured for the one or more uplink channels or reference signals, and the multiple TCI states are associated with the common TAG.

In a twelfth aspect, alone or in combination with one or more of the first through eleventh aspects, multiple TCI states are configured for the one or more uplink channels or reference signals, the multiple TCI states are associated with different TAGs, and selecting the common TAG includes selecting the common TAG from among the different TAGs.

In a thirteenth aspect, alone or in combination with one or more of the first through twelfth aspects, the one or more uplink channels or reference signals include one or more SRS resources of an SRS resource set, and the common TAG rule specifies that SRS resources of the SRS resource set are to be associated with the common TAG.

In a fourteenth aspect, alone or in combination with one or more of the first through thirteenth aspects, the common TAG rule specifies that uplink or joint TCI states of the SRS resources in the SRS resource set are to be associated with the common TAG.

In a fifteenth aspect, alone or in combination with one or more of the first through fourteenth aspects, the common TAG rule specifies that if a TAG is indicated for an uplink or joint TCI state of an SRS resource, the TAG that is indicated is to be the common TAG and other TAGs for uplink or joint TCI states of other SRS resources are to be ignored.

In a sixteenth aspect, alone or in combination with one or more of the first through fifteenth aspects, the TAG that is indicated has a lowest ID among SRS resources of the SRS resource set.

In a seventeenth aspect, alone or in combination with one or more of the first through sixteenth aspects, the TAG that is indicated has a highest ID among SRS resources of the SRS resource set.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., base station 110) performs operations associated with using a common TAG for multiple TRP operation.

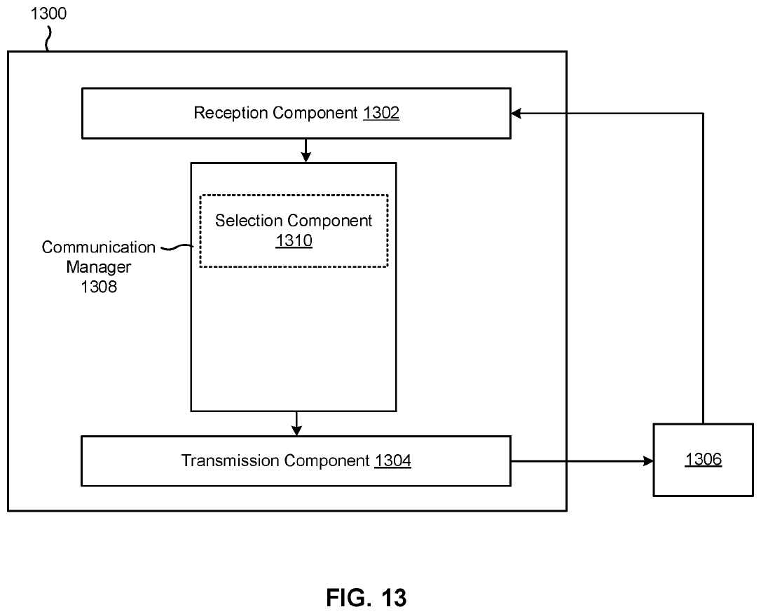

As shown in FIG. 11, in some aspects, process 1100 may include transmitting an indication of at least two TAGs per serving cell for multiple TRP operation, where each TAG is associated with or included in an uplink or joint TCI state (block 1110). For example, the network entity (e.g., using communication manager 1308 and/or transmission component 1304 depicted in FIG. 13) may transmit an indication of at least two TAGs per serving cell for multiple TRP operation, where each TAG is associated with or included in an uplink or joint TCI state, as described above in connection with FIGS. 5-9.

As further shown in FIG. 11, in some aspects, process 1100 may include transmitting an activation message that activates one or more TCI states for one or more uplink channels or reference signals (block 1120). For example, the network entity (e.g., using communication manager 1308 and/or transmission component 1304 depicted in FIG. 13) may transmit an activation message that activates one or more TCI states for one or more uplink channels or reference signals, as described above in connection with FIGS. 5-9.

As further shown in FIG. 11, in some aspects, process 1100 may include selecting a common TAG for the one or more uplink channels or reference signals based at least in part on a common TAG rule (block 1130). For example, the network entity (e.g., using communication manager 1308 and/or selection component 1310 depicted in FIG. 13) may select a common TAG for the one or more uplink channels or reference signals based at least in part on a common TAG rule, as described above.

As further shown in FIG. 11, in some aspects, process 1100 may include receiving a reference signal or a communication on an uplink channel using the common TAG (block 1140). For example, the network entity (e.g., using communication manager 1308 and/or reception component 1302 depicted in FIG. 13) may receive a reference signal or a communication on an uplink channel using the common TAG, as described above in connection with FIGS. 5-9.

Process 1100 may include additional aspects, such as any single aspect or any combination of aspects described below and/or in connection with one or more other processes described elsewhere herein.

In a first aspect, the common TAG rule specifies that if the one or more uplink channels or reference signals are scheduled by DCI of a same CORESET pool index, the one or more uplink channels or reference signals are to use the common TAG.

In a second aspect, alone or in combination with the first aspect, the common TAG rule specifies that TCI states activated by a same MAC CE of a same CORESET pool index are to use the common TAG.

In a third aspect, alone or in combination with one or more of the first and second aspects, the common TAG rule specifies that uplink or joint TCI states of the one or more uplink channels or reference signals are to use the common TAG.

In a fourth aspect, alone or in combination with one or more of the first through third aspects, the common TAG rule specifies that if a TAG is indicated for uplink or joint TCI states, the TAG that is indicated is to be the common TAG and other TAGs for other uplink or joint TCI states are to be ignored.

In a fifth aspect, alone or in combination with one or more of the first through fourth aspects, the TAG that is indicated has a lowest ID among activated TCI states.

In a sixth aspect, alone or in combination with one or more of the first through fifth aspects, the TAG that is indicated has a highest ID among activated TCI states.

In a seventh aspect, alone or in combination with one or more of the first through sixth aspects, selecting the common TAG includes selecting a TAG that has a lowest ID among the at least two TAGs.

In an eighth aspect, alone or in combination with one or more of the first through seventh aspects, selecting the common TAG includes selecting a TAG that has a highest ID among the at least two TAGs.

In a ninth aspect, alone or in combination with one or more of the first through eighth aspects, the common TAG rule specifies that if no TAG is associated with the one or more uplink channels or reference signals, a default TAG is to be the common TAG.

In a tenth aspect, alone or in combination with one or more of the first through ninth aspects, process 1100 includes transmitting the default TAG in an RRC message.

In an eleventh aspect, alone or in combination with one or more of the first through tenth aspects, multiple TCI states are configured for the one or more uplink channels or reference signals, and the multiple TCI states are associated with the common TAG.

In a twelfth aspect, alone or in combination with one or more of the first through eleventh aspects, multiple TCI states are configured for the one or more uplink channels or reference signals, the multiple TCI states are associated with different TAGs, and selecting the common TAG includes selecting the common TAG from among the different TAGs.

In a thirteenth aspect, alone or in combination with one or more of the first through twelfth aspects, the one or more uplink channels or reference signals include one or more SRS resources of an SRS resource set, and the common TAG rule specifies that SRS resources of the SRS resource set are to be associated with the common TAG.

In a fourteenth aspect, alone or in combination with one or more of the first through thirteenth aspects, the common TAG rule specifies that uplink or joint TCI states of the SRS resources in the SRS resource set are to be associated with the common TAG.

In a fifteenth aspect, alone or in combination with one or more of the first through fourteenth aspects, the common TAG rule specifies that if a TAG is indicated for an uplink or joint TCI state of an SRS resource, the TAG that is indicated is to be the common TAG and other TAGs for uplink or joint TCI states of other SRS resources are to be ignored.

In a sixteenth aspect, alone or in combination with one or more of the first through fifteenth aspects, the TAG that is indicated has a lowest ID among SRS resources of the SRS resource set.

In a seventeenth aspect, alone or in combination with one or more of the first through sixteenth aspects, the TAG that is indicated has a highest ID among SRS resources of the SRS resource set.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE (e.g., a UE 120), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, network entity, TRP, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the UE described in connection with FIG. 2. The communication manager 1208 may be, or be similar to, the communication manager 140 depicted in FIGS. 1 and 2. For example, in some aspects, the communication manager 1208 may be configured to perform one or more of the functions described as being performed by the communication manager 140. In some aspects, the communication manager 1208 may include the reception component 1202 and/or the transmission component 1204. The communication manager 140 may include a selection component 1210, among other examples.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive an indication of at least two TAGs per serving cell for multiple TRP operation, where each TAG is associated with or included in an uplink or joint TCI state. The reception component 1202 may receive an activation message that activates one or more TCI states for one or more uplink channels or reference signals. The selection component 1210 may select a common TAG for the one or more uplink channels or reference signals based at least in part on a common TAG rule. The transmission component 1204 may transmit a reference signal or a communication on an uplink channel using the common TAG. The reception component 1202 may receive the default TAG in a radio resource control (RRC) message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity (e.g., a base station 110), or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, TRP, network entity, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the base station described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150. In some aspects, the communication manager 1308 may include the reception component 1302 and/or the transmission component 1304. The communication manager 1308 may include a selection component 1310, among other examples.

In some aspects, the apparatus 1300 may be configured to perform one or more operations described herein in connection with FIGS. 1-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The transmission component 1304 may transmit an indication of at least two TAGs per serving cell for multiple TRP operation, where each TAG is associated with or included in an uplink or joint TCI state. The transmission component 1304 may transmit an activation message that activates one or more TCI states for one or more uplink channels or reference signals. The selection component 1310 may select a common TAG for the one or more uplink channels or reference signals based at least in part on a common TAG rule. The reception component 1302 may receive a reference signal or a communication on an uplink channel using the common TAG. The transmission component 1304 may transmit the default TAG in an RRC message.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving an indication of at least two timing advance groups (TAGs) per serving cell for multiple transmit receive point operation, wherein each TAG is associated with or included in an uplink or joint transmission configuration indicator (TCI) state; receiving an activation message that activates one or more TCI states for one or more uplink channels or reference signals; selecting a common TAG for the one or more uplink channels or reference signals based at least in part on a common TAG rule; and transmitting a reference signal or a communication on an uplink channel using the common TAG.

Aspect 2: The method of Aspect 1, wherein the common TAG rule specifies that if the one or more uplink channels or reference signals are scheduled by downlink control information of a same control resource set (CORESET) pool index, the one or more uplink channels or reference signals are to use the common TAG.

Aspect 3: The method of Aspect 1 or 2, wherein the common TAG rule specifies that TCI states activated by a same medium access control control element (MAC CE) of a same control resource set (CORESET) pool index are to use the common TAG.

Aspect 4: The method of any of Aspects 1-3, wherein the common TAG rule specifies that uplink or joint TCI states of the one or more uplink channels or reference signals are to use the common TAG.

Aspect 5: The method of any of Aspects 1-4, wherein the common TAG rule specifies that if a TAG is indicated for uplink or joint TCI states, the TAG that is indicated is to be the common TAG and other TAGs for other uplink or joint TCI states are to be ignored.

Aspect 6: The method of Aspect 5, wherein the TAG that is indicated has a lowest identifier among activated TCI states.

Aspect 7: The method of Aspect 5, wherein the TAG that is indicated has a highest identifier among activated TCI states.

Aspect 8: The method of any of Aspects 1-7, wherein selecting the common TAG includes selecting a TAG that has a lowest identifier among the at least two TAGs.

Aspect 9: The method of any of Aspects 1-7, wherein selecting the common TAG includes selecting a TAG that has a highest identifier among the at least two TAGs.

Aspect 10: The method of Aspect 1, wherein the common TAG rule specifies that if no TAG is associated with the one or more uplink channels or reference signals, a default TAG is to be the common TAG.

Aspect 11: The method of Aspect 10, further comprising receiving the default TAG in a radio resource control (RRC) message.

Aspect 12: The method of any of Aspects 1-11, wherein multiple TCI states are configured for the one or more uplink channels or reference signals, and wherein the multiple TCI states are associated with the common TAG.

Aspect 13: The method of any of Aspects 1-11, wherein multiple TCI states are configured for the one or more uplink channels or reference signals, wherein the multiple TCI states are associated with different TAGs, and wherein selecting the common TAG includes selecting the common TAG from among the different TAGs.

Aspect 14: The method of any of Aspects 1-13, wherein the one or more uplink channels or reference signals include one or more sounding reference signal (SRS) resources of an SRS resource set, and wherein the common TAG rule specifies that SRS resources of the SRS resource set are to be associated with the common TAG.

Aspect 15: The method of Aspect 14, wherein the common TAG rule specifies that uplink or joint TCI states of the SRS resources in the SRS resource set are to be associated with the common TAG.

Aspect 16: The method of Aspect 14 or 15, wherein the common TAG rule specifies that if a TAG is indicated for an uplink or joint TCI state of an SRS resource, the TAG that is indicated is to be the common TAG and other TAGs for uplink or joint TCI states of other SRS resources are to be ignored.

Aspect 17: The method of Aspect 16, wherein the TAG that is indicated has a lowest identifier among SRS resources of the SRS resource set.

Aspect 18: The method of Aspect 16, wherein the TAG that is indicated has a highest identifier among SRS resources of the SRS resource set.

Aspect 19: A method of wireless communication performed by a network entity, comprising: transmitting an indication of at least two timing advance groups (TAGs) per serving cell for multiple transmit receive point operation, wherein each TAG is associated with or included in an uplink or joint transmission configuration indicator (TCI) state; transmitting an activation message that activates one or more TCI states for one or more uplink channels or reference signals; selecting a common TAG for the one or more uplink channels or reference signals based at least in part on a common TAG rule; and receiving a reference signal or a communication on an uplink channel using the common TAG.

Aspect 20: The method of Aspect 19, wherein the common TAG rule specifies that if the one or more uplink channels or reference signals are scheduled by downlink control information of a same control resource set (CORESET) pool index, the one or more uplink channels or reference signals are to use the common TAG.

Aspect 21: The method of Aspect 19 or 20, wherein the common TAG rule specifies that TCI states activated by a same medium access control control element (MAC CE) of a same control resource set (CORESET) pool index are to use the common TAG.

Aspect 22: The method of any of Aspects 19-21, wherein the common TAG rule specifies that uplink or joint TCI states of the one or more uplink channels or reference signals are to use the common TAG.

Aspect 23: The method of any of Aspects 19-22, wherein the common TAG rule specifies that if a TAG is indicated for uplink or joint TCI states, the TAG that is indicated is to be the common TAG and other TAGs for other uplink or joint TCI states are to be ignored.

Aspect 24: The method of Aspect 23, wherein the TAG that is indicated has a lowest identifier among activated TCI states.

Aspect 25: The method of Aspect 23, wherein the TAG that is indicated has a highest identifier among activated TCI states.

Aspect 26: The method of Aspect 19, wherein selecting the common TAG includes selecting a TAG that has a lowest identifier among the at least two TAGs.

Aspect 27: The method of Aspect 19, wherein selecting the common TAG includes selecting a TAG that has a highest identifier among the at least two TAGs.

Aspect 28: The method of Aspect 19, wherein the common TAG rule specifies that if no TAG is associated with the one or more uplink channels or reference signals, a default TAG is to be the common TAG.

Aspect 29: The method of Aspect 28, further comprising transmitting the default TAG in a radio resource control (RRC) message.

Aspect 30: The method of any of Aspects 19-29, wherein multiple TCI states are configured for the one or more uplink channels or reference signals, and wherein the multiple TCI states are associated with the common TAG.

Aspect 31: The method of any of Aspects 19-29, wherein multiple TCI states are configured for the one or more uplink channels or reference signals, wherein the multiple TCI states are associated with different TAGs, and wherein selecting the common TAG includes selecting the common TAG from among the different TAGs.

Aspect 32: The method of any of Aspects 19-31, wherein the one or more uplink channels or reference signals include one or more sounding reference signal (SRS) resources of an SRS resource set, and wherein the common TAG rule specifies that SRS resources of the SRS resource set are to be associated with the common TAG.

Aspect 33: The method of Aspect 32, wherein the common TAG rule specifies that uplink or joint TCI states of the SRS resources in the SRS resource set are to be associated with the common TAG.

Aspect 34: The method of Aspect 32, wherein the common TAG rule specifies that if a TAG is indicated for an uplink or joint TCI state of an SRS resource, the TAG that is indicated is to be the common TAG and other TAGs for uplink or joint TCI states of other SRS resources are to be ignored.

Aspect 35: The method of Aspect 32, wherein the TAG that is indicated has a lowest identifier among SRS resources of the SRS resource set.

Aspect 36: The method of Aspect 32, wherein the TAG that is indicated has a highest identifier among SRS resources of the SRS resource set.

Aspect 37: An apparatus for wireless communication at a device, comprising a processor; memory coupled with the processor; and instructions stored in the memory and executable by the processor to cause the apparatus to perform the method of one or more of Aspects 1-36.

Aspect 38: A device for wireless communication, comprising a memory and one or more processors coupled to the memory, the one or more processors configured to perform the method of one or more of Aspects 1-36.

Aspect 39: An apparatus for wireless communication, comprising at least one means for performing the method of one or more of Aspects 1-36.

Aspect 40: A non-transitory computer-readable medium storing code for wireless communication, the code comprising instructions executable by a processor to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving an indication of at least two timing advance groups (TAGs) per serving cell for multiple transmit receive point operation, wherein each TAG is associated with an uplink or joint transmission configuration indicator (TCI) state;
receiving an activation message that activates one or more TCI states for one or more uplink channels or reference signals;
selecting a common TAG for the one or more uplink channels or reference signals based at least in part on a common TAG rule; and
transmitting a reference signal or a communication on an uplink channel using the common TAG.

2. The method of claim 1, wherein the common TAG rule specifies that if the one or more uplink channels or reference signals are scheduled by downlink control information of a same control resource set (CORESET) pool index, the one or more uplink channels or reference signals are to use the common TAG.

3. The method of claim 11, wherein the common TAG rule specifies that TCI states activated by a same medium access control control element (MAC CE) of a same control resource set (CORESET) pool index are to use the common TAG.

4. The method of claim 1, wherein the common TAG rule specifies that uplink or joint TCI states of the one or more uplink channels or reference signals are to use the common TAG.

5. The method of claim 1, wherein the common TAG rule specifies that if a TAG is indicated for uplink or joint TCI states, the TAG that is indicated is to be the common TAG and other TAGs for other uplink or joint TCI states are to be ignored.

6. The method of claim 1, wherein selecting the common TAG includes selecting a TAG that has a lowest identifier among the at least two TAGs.

7. The method of claim 1, wherein selecting the common TAG includes selecting a TAG that has a highest identifier among the at least two TAGs.

8. The method of claim 1, wherein the common TAG rule specifies that if no TAG is associated with the one or more uplink channels or reference signals, a default TAG is to be the common TAG.

9. The method of claim 1, wherein the one or more uplink channels or reference signals include one or more sounding reference signal (SRS) resources of an SRS resource set, and wherein the common TAG rule specifies that SRS resources of the SRS resource set are to be associated with the common TAG.

10. The method of claim 9, wherein the common TAG rule specifies that uplink or joint TCI states of the SRS resources in the SRS resource set are to be associated with the common TAG.

11. The method of claim 9, wherein the common TAG rule specifies that if a TAG is indicated for an uplink or joint TCI state of an SRS resource, the TAG that is indicated is to be the common TAG and other TAGs for uplink or joint TCI states of other SRS resources are to be ignored.

12. A method of wireless communication performed by a network entity, comprising:
transmitting an indication of at least two timing advance groups (TAGs) per serving cell for multiple transmit receive point operation, wherein each TAG is associated with an uplink or joint transmission configuration indicator (TCI) state;
transmitting an activation message that activates one or more TCI states for one or more uplink channels or reference signals;
selecting a common TAG for the one or more uplink channels or reference signals based at least in part on a common TAG rule; and
receiving a reference signal or a communication on an uplink channel using the common TAG.

13-19. (canceled)

20. A user equipment (UE) for wireless communication, comprising:
a memory; and
one or more processors, coupled to the memory, configured to:
receive an indication of at least two timing advance groups (TAGs) per serving cell for multiple transmit receive point operation, wherein each TAG is associated with an uplink or joint transmission configuration indicator (TCI) state;
receive an activation message that activates one or more TCI states for one or more uplink channels or reference signals;
select a common TAG for the one or more uplink channels or reference signals based at least in part on a common TAG rule; and
transmit a reference signal or a communication on an uplink channel using the common TAG.

21. The UE of claim 20, wherein the common TAG rule specifies that if the one or more uplink channels or reference signals are scheduled by downlink control information of a same control resource set (CORESET) pool index, the one or more uplink channels or reference signals are to use the common TAG.

22. The UE of claim 20, wherein the common TAG rule specifies that TCI states activated by a same medium access control control element (MAC CE) of a same control resource set (CORESET) pool index are to use the common TAG.

23. The UE of claim 20, wherein the common TAG rule specifies that uplink or joint TCI states of the one or more uplink channels or reference signals are to use the common TAG.

24. The UE of claim 20, wherein the common TAG rule specifies that if a TAG is indicated for uplink or joint TCI states, the TAG that is indicated is to be the common TAG and other TAGs for other uplink or joint TCI states are to be ignored.

25. The UE of claim 20, wherein the one or more processors, to select the common TAG, are configured to select a TAG that has a lowest identifier among the at least two TAGs.

26. The UE of claim 20, wherein the one or more processors, to select the common TAG, are configured to select a TAG that has a highest identifier among the at least two TAGs.

27. The UE of claim 20, wherein the common TAG rule specifies that if no TAG is associated with the one or more uplink channels or reference signals, a default TAG is to be the common TAG.

28. The UE of claim 20, wherein the one or more uplink channels or reference signals include one or more sounding reference signal (SRS) resources of an SRS resource set, and wherein the common TAG rule specifies that SRS resources of the SRS resource set are to be associated with the common TAG.

29. The UE of claim 28, wherein the common TAG rule specifies that uplink or joint TCI states of the SRS resources in the SRS resource set are to be associated with the common TAG.

30. The UE of claim 28, wherein the common TAG rule specifies that if a TAG is indicated for an uplink or joint TCI state of an SRS resource, the TAG that is indicated is to be the common TAG and other TAGs for uplink or joint TCI states of other SRS resources are to be ignored.

31. A network entity for wireless communication, comprising:
a memory; and
one or more processors, coupled to the memory, configured to:
transmit an indication of at least two timing advance groups (TAGs) per serving cell for multiple transmit receive point operation, wherein each TAG is associated with an uplink or joint transmission configuration indicator (TCI) state;
transmit an activation message that activates one or more TCI states for one or more uplink channels or reference signals;
select a common TAG for the one or more uplink channels or reference signals based at least in part on a common TAG rule; and
receive a reference signal or a communication on an uplink channel using the common TAG.

32. The network entity of claim 31, wherein the common TAG rule specifies that if the one or more uplink channels or reference signals are scheduled by downlink control information of a same control resource set (CORESET) pool index, the one or more uplink channels or reference signals are to use the common TAG.

33. The network entity of claim 31, wherein the common TAG rule specifies that TCI states activated by a same medium access control control element (MAC CE) of a same control resource set (CORESET) pool index are to use the common TAG.

34. The network entity of claim 31, wherein the common TAG rule specifies that uplink or joint TCI states of the one or more uplink channels or reference signals are to use the common TAG.

35. The network entity of claim 31, wherein the common TAG rule specifies that if a TAG is indicated for uplink or joint TCI states, the TAG that is indicated is to be the common TAG and other TAGs for other uplink or joint TCI states are to be ignored.

36. The network entity of claim 35, wherein the one or more processors, to select the common TAG, are configured to select a TAG that has a lowest identifier among the at least two TAGs.

37. The network entity of claim 35, wherein the one or more processors, to select the common TAG, are configured to select a TAG that has a highest identifier among the at least two TAGs.

38. The network entity of claim 35, wherein the common TAG rule specifies that if no TAG is associated with the one or more uplink channels or reference signals, a default TAG is to be the common TAG.
